(19) United States
(12) Patent Application Publication
(10) Pub. No.: US 2008/0166200 A1
(43) Pub. Date: Jul. 10, 2008

(54) Device for establishing desired minimum preload condition obtained in a fastener shank

(75) Inventors: David S. Hippensteele, Fort Wayne, IN (US); Nick C. Knappenberger, Fort Wayne, IN (US)

Correspondence Address: George Pappas, Suite 300, 919 S. Harrison Street, Fort Wayne, IN, 46802, US

(73) Assignee: McCoy Bolt Works, Inc.

(21) Appl. No.: 11/651,686

(22) Filed: Jan. 10, 2007

(51) Int. Cl. F16B 31/00

(52) U.S. Cl. 411/14.5

(57) ABSTRACT

A device integrally formed with a threaded nut or bolt for establishing that a desired minimum preload condition has been attained. The device includes an annular portion including a disk shaped bottoming surface and a top area. A frusto-conical portion circumscribes the annular portion and includes a frusto-conical bottoming surface with an inner smaller diameter abutting the disk shaped bottoming surface and an outer larger diameter spaced longitudinally from the disk shaped bottoming surface. The frusto-conical bottoming surface forms an angle with a plane transverse to the longitudinal of between ten (10) and thirty (30) degrees. The device is preferably made of steel having carbon content of less than 0.3%.

### TECHNICAL FIELD

The present invention relates to the general technical field of fasteners and, more particularly, to fastener devices such as nuts for threadingly engaging a fastener shank or bolts including a fastener shank whereby, upon use thereof, a desired minimum preload condition which is attained in the fastener shank can be established.

### BACKGROUND OF THE INVENTION

It is often desirable to preload a fastener shank to a desired preload condition so as to attain and maintain a particular design clamping force. Fastener shanks are currently being preloaded in different applications and industries including for example, in the construction of buildings, manufacture of automobiles and trucks, etc. Various fasteners and methods of preloading such fasteners to a desired preload condition are disclosed, for example, in Ohringer, U.S. Pat. No. 3,834,269; Wagner, U.S. Pat. No. 3,960,048; Miki et al, U.S. Pat. No. 3,992,974; Pamer, U.S. Pat. No. 4,293,256; Pamer et al, U.S. Pat. No. 4,498,825; Henriksen, U.S. Pat. No. 5,827,025; Bächle, U.S. Pat. No. 6,213,885; Schatz, Publication No. U.S. 2003/0039527 A1; and, Aspers, U.S. Pat. No. 4,333,220. These prior fasteners include various means adapted to elastically and/or plastically yield upon the fastener attaining certain desired load conditions. Miki et al, U.S. Pat. No. 3,992,974, for example, discloses a truncated cone washer adapted to plastically deform upon application of a desired load thereto. Also, Miki et al, U.S. Pat. No. 3,992,974 and Aspers, U.S. Pat. No. 4,333,220 disclose methods of using such fasteners whereby, while loading the fastener shank, the torque and displacement angle are monitored for establishing the preload condition of the fastener shank.

When using a fastener which is designed to be monitored for establishing that a desired minimum preload condition has been attained, the torque and/or force on the fastener shank is monitored while the shank elastically deforms until a means on the fastener plastically or elastically collapses thereby indicating a desired preload condition has been reached or attained. Typically this is determined by the point at which the generally linearly increasing load on the fastener shank suddenly levels off while the fastener, nevertheless, continues to be turned. That is, the point at which, although the fastener is being turned/advanced, the torque/load generally remains constant or does not linearly increase. The fastener is then further turned and tightened until the load on the fastener shank starts to again linearly increase thereby assuring that the fastener has attained and will continue to maintain the desired preload condition.

Although many different fasteners currently exist for use in establishing that a desired minimum preload condition has been attained, an improved such fastener device is needed whereby a desired minimum preload condition in a fastener shank can be more accurately and easily be established and, thereafter, maintained and wherein the cost of such fastening device remains relatively low for use in various applications including the automotive and truck industries.

### SUMMMARY OF THE INVENTION

It is the principal object of the present invention to provide a new and improved fastener device for establishing that a desired minimum preload condition has been attained in a fastener shank and wherein such minimum preload condition can relatively accurately be established, and further, wherein such fastener device is relatively lower in cost.

In summary, the present invention is a device for establishing that a desired minimum preload condition has been attained in a fastener shank which is used in maintaining two (2) bodies together. The device is used by being located and clamped between the bodies.

The device includes an annular portion provided with a longitudinally extending central bore which is adapted to receive the fastener shank. The central bore has a first end at one longitudinal end and a second end at its opposite longitudinal end. The annular portion includes a disk shaped bottoming surface at the first end of the central bore and a top area at the second end of the central bore. The bottoming surface is transverse to the central bore. An annular portion thickness is thus defined between the disk shaped bottoming surface and the top area of the annular portion.

The device further includes a frusto-conical portion circumscribing and being integrally formed with the annular portion. The frusto-conical portion includes a frusto-conical bottoming surface having an inner smaller diameter abutting the disk shaped bottoming surface and, further, includes an outer larger diameter which is located in a plane transverse to the central bore and longitudinally spaced from the disk shaped bottoming surface. The frusto-conical portion includes a top frusto-conical area which is adjacent to and generally circumscribing the annular portion top area. A frusto-conical thickness is thus defined between the frusto-conical bottoming surface and the top frusto-conical area.

The device is formed of a material whereby, upon placement of a fastener shank through the central bore and use of the fastener shank in drawing the two (2) bodies together and thereby clamping the device therebetween and reaching a desired minimum preload condition in the fastener shank, the frusto-conical portion plastically deforms longitudinally thereby allowing the disk shaped bottoming surface to be drawn toward and to abut one of the bodies.

By monitoring the load on the fastener shank, the desired preload condition thereof is established by determining when the frusto-conical portion plastically deforms. Thereafter, to maintain that desired preload condition, the fastener shank is further loaded until the disk shaped bottoming surface abuts one of the bodies.

Preferably, the device annular portion thickness and the frusto-conical thickness are both 0.25 to 0.7 times the sum of the frusto-conical portion smaller diameter less the cental bore diameter. The frusto-conical bottoming surface preferably forms an angle with a plane transverse to the longitudinally extending central bore of between 10 and 30 degrees. Yet, more preferably, the device is made of steel having carbon content of less than 0.3%.

In a most preferred embodiment of the device, as described, a first body is integrally formed with the device adjacent the annular portion top area and includes a threaded bore collinear with the annular portion central bore. The threaded bore is adapted to threadingly engage a threaded shank. The first body further includes tool engaging surfaces whereby the first body and integral device may be turned together about a threaded shank for thereby threadingly advancing the device toward a second body. Yet more preferably, the annular portion central bore is also threaded and is adapted to threadingly engage the threaded shank. Additionally, radius surfaces extend between the tool engaging surfaces and the frusto-conical area and such radius surfaces are located above the annular portion top area.

In another embodiment, the device as described includes a first body integrally formed with the device adjacent to the annular portion top area and the first body includes tool engaging surfaces. A fastener shank is integrally formed with the device filling the annular portion central bore and extending longitudinally therefrom beyond the disk shaped bottoming surface. Preferably, the fastener shank is at least partially threaded and adapted to threadingly engage a threaded bore in a second body whereby the first body and integral device may be turned and threadingly advanced toward the second body and into the second body threaded bore.

### BRIEF DESCRIPTION OF THE DRAWINGS

The above mentioned and other features and objects of this invention and the manner of obtaining them will become more apparent and the invention itself will be better understood by reference to the following description of embodiments of the invention taken in conjunction with the accompanying drawings wherein:

FIG. 1 is a diagrammatic view of an axle attached to a suspension system utilizing devices constructed in accordance with the principles of the present invention;

FIG. 2 is a side elevation view of a load detecting fastener nut incorporating an integrally formed device in accordance with the principles of the present invention;

FIG. 3 is a top plan view of the fastener nut shown in FIG. 2;

FIG. 4 is a side elevation view of the fastener nut shown in FIG. 3 taken along line 4-4;

FIG. 5 is a cross sectional view of the fastener nut shown in FIG. 3 taken along line 5-5;

FIG. 6 is a partial cross sectional view of a load detecting fastener bolt incorporating an integrally formed device in accordance with the principles of the present invention;

FIG. 7 is a diagrammatic view depicting automated controlled loading of fasteners incorporating devices in accordance with the principles of the present invention for establishing desired minimum preload conditions; and,

FIG. 8 is a diagrammatic torque versus advanced angle graph depicting the monitoring of devices of the present invention being loaded and whereby the desired minimum preload condition attained is established.

Corresponding reference characters indicate corresponding parts throughout the several views of the drawings.

The exemplifications set out herein illustrate preferred embodiments of the invention in one form thereof and such exemplifications are not to be construed as limiting the scope of the disclosure or the scope of the invention in any manner.

### DETAILED DESCRIPTION OF SPECIFIC EMBODIMENTS

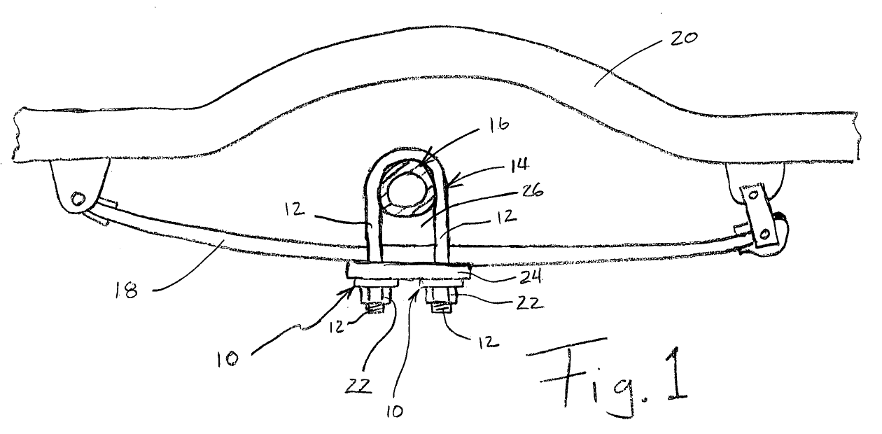

Referring initially to FIG. 1, devices constructed in accordance with the principles of the present invention are generally designated by the numeral 10 and are used on each of the threaded shanks 12 of a U-shaped bolt 14. In this particular application, the devices 10 and U-bolt 14 are used for clamping and maintaining axle 16 onto a leaf spring 18 attached to a vehicle frame 20.

Each device 10 is used for establishing that a desired minimum preload condition has been attained in a fastener shank which is used in maintaining two bodies together when the device 10 is located and clamped between the two bodies. For example, in FIG. 1 the devices 10 are used in a manner whereby shanks 12 extend therethrough and are clamped between a first body in the form of threaded nuts 22 and a second body in the form of plate 24, spring 18, filler 26 and axle 16. More particularly, as the nuts 22 are threaded onto the shanks 12 and tightened thereon, the devices 10 are clamped between the first and second bodies and the shanks 12 are loaded or placed in tension. As more fully described hereinbelow, the devices 10 are used during this tightening or preloading process for establishing that a desired minimum preload condition has been attained in the fastener shanks 12.

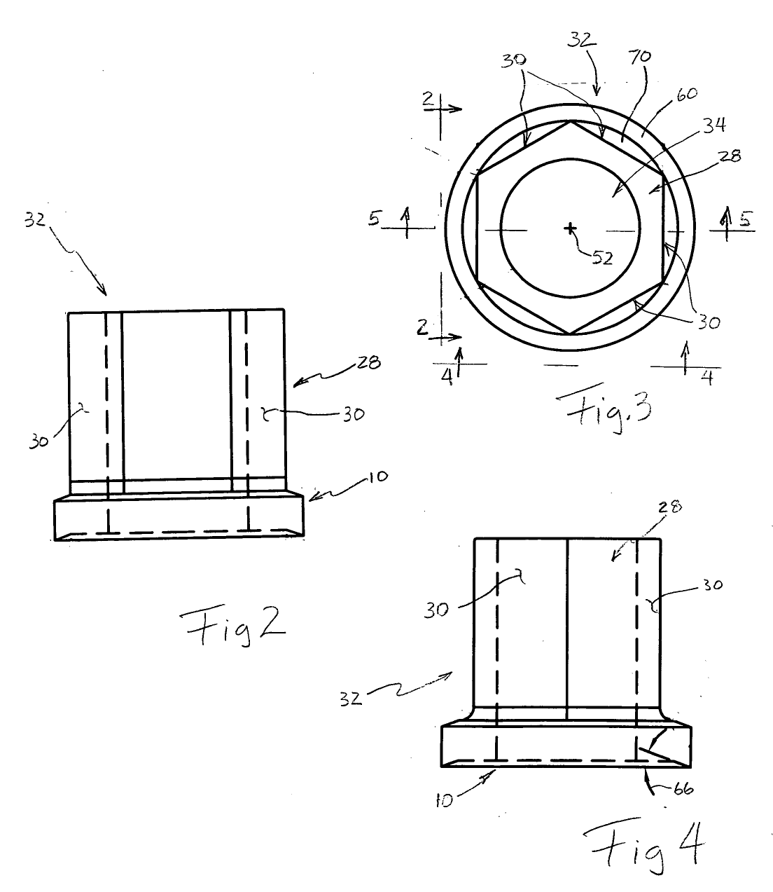

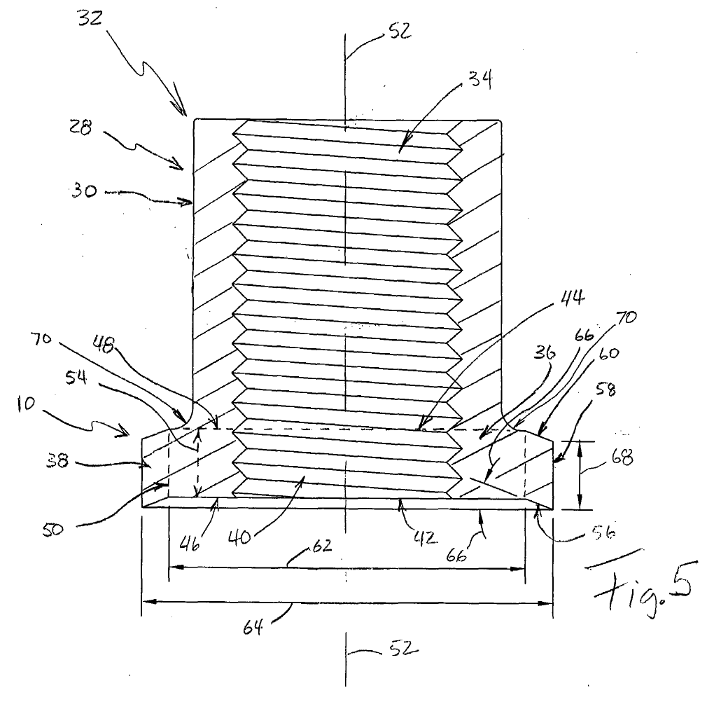

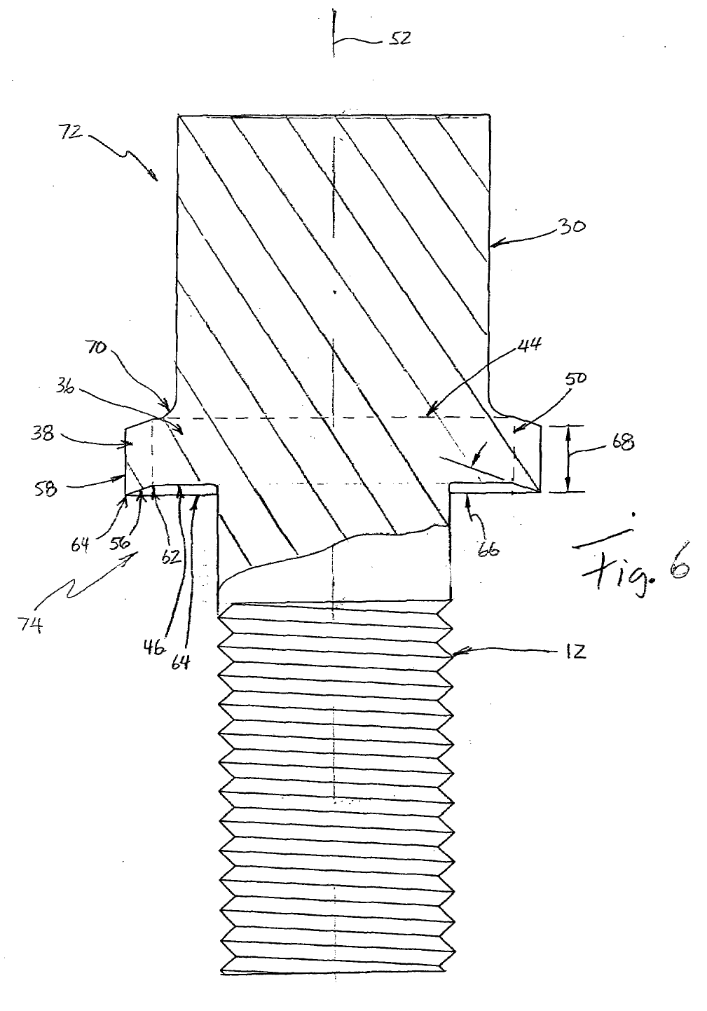

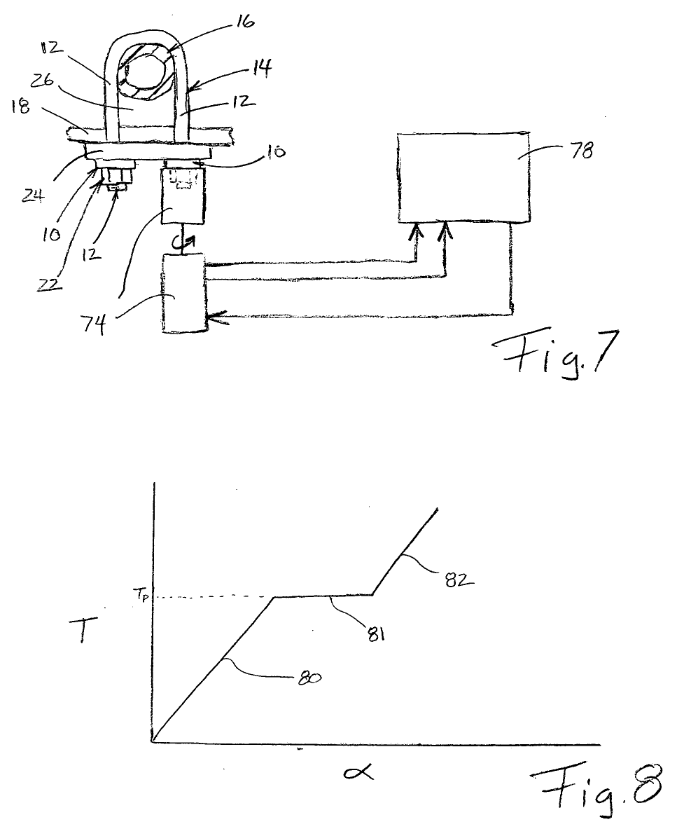

Referring now to FIGS. 2-5, there is shown a device 10 constructed in accordance with the principles of the present invention in a preferred form wherein the device 10 is integrally formed with a first body 28. Together, the integrally formed device 10 and first body 28 form a load detecting fastener nut generally designated by the numeral 32. The first body portion 28 of load detecting nut 32 is provided with hex tool engaging surfaces 30. A threaded bore 34 extends longitudinally through both the device 10 portion and the first body 28 portion of the load detecting nut 32.

As best seen in FIG. 5, the device 10 portion of the load detecting fastener nut 32 is defined by an annular portion 36 integrally formed with the first body 28, and a frusto-conical portion 38 circumscribing and integrally formed with the annular portion 36. The annular portion 36 is defined by a disk shaped bottoming surface 46, a disk shaped top area 48, (shown with a dash line in FIG. 5), an outer cylindrical area 50 (shown with in a dash line in FIG. 5) and a longitudinally extending central bore 40 having a first longitudinal end 42, a second longitudinal end 44 at the other end thereof and being collinear with threaded bore 34 and longitudinal axis 52. Preferably, the central bore 40 of the annular portion 36 is threaded together with the threaded bore 34 of first body 28 as shown for receiving a threaded shank 12 therethrough. The disk shaped bottoming surface 46 is generally transverse to the longitudinally extending bores 34 and 40 and, thus, also axis 52. An annular portion thickness depicted by dash arrows 54 is, thus, defined between the disk shaped bottoming surface 46 and the disk shaped top area 48.

The frusto-conical portion 38 circumscribes the annular portion 36 and is defined by a frusto-conical bottoming surface 56, an outer cylindrical surface or area 58, a top frusto-conical area or surface 60, and the outer cylindrical area 50 of annular portion 36. The frusto-conical bottoming surface 56 has an inner smaller diameter depicted by the arrows 62. The inner smaller diameter of the frusto-conical bottoming surface abuts the disk shaped bottoming surface 46 of the annular portion 36. The frusto-conical bottoming surface 56 also has an outer larger diameter depicted by the arrows 64 located at the intersection between the frusto-conical surface 56 and the outer cylindrical area or surface 58. The outer larger diameter 64 is located in a plane transverse to the longitudinal axis 52 and bores 34, 40. The outer larger diameter 64 is also longitudinally spaced from the disk shaped bottoming surface 46 such that the frusto-conical bottoming surface 56 forms an angle depicted by the arrows designated with the numeral 66. Preferably, the angle 66 is ten (10) to thirty (30) degrees and most preferably is twenty (20) degrees. A frusto-conical thickness is also defined between the frusto-conical bottoming surface 56 and the top frusto-conical area 60 as generally designated by the arrows 68.

The load detecting fastener nut 32 is preferably made of low carbon steel. More preferably, the load detecting fastener nut 32 is made of mild steel having a carbon content of less than 0.3%. Additionally, for optimal performance in establishing that a desired minimum preload condition has been attained, both the annular portion thickness 54 and the frusto-conical portion thickness 68 are preferably 0.25-0.7 times the sum of the frusto-conical portion smaller diameter 62 less the diameter of the central bore 40; and, the angle 66 between the frusto-conical bottoming surface 56 and a plane transverse to the longitudinally extending axis 52 and central bores 34, 40 is preferably between ten (10) and thirty (30) degrees. Yet more preferably, the tool engaging surfaces 30 are joined with the top frusto-conical areas or surfaces 60 via radius surfaces 70.

In the embodiment shown in FIG. 6, the device 10 is integrally formed with a first body 72 having hex tool engaging surfaces 30 similar to the load detecting fastener nut 32. However, in the embodiment of FIG. 6, the first body 72 does not include a threaded bore and, instead, a fastener shank 12 is integrally formed with the device 10 and first body 72 thereby forming a load detecting fastening bolt 74. Shank 12 is partially threaded as shown. The central bore 40 of the device 10 is, thus, essentially filled or eliminated and the shank 12 extends longitudinally from the device 10 from the disk shaped bottoming surface 46. The threaded shank 12 of bolt 74 is collinear with the longitudinal axis 52 and is adapted to threadingly engage a threaded bore in a second body such that, by engaging the surfaces 30 with an appropriate tool and turning the bolt 74 about the axis 52, bolt 74 may be threadingly advanced toward the second body and into the threaded bore of such second body.

In operation load detecting fastener nut 32 and/or bolt 74 are threadingly advanced toward a second body thereby clamping and compressing the device 10 between the first bodies 28, 72 and a second body i.e. plate 24 etc., of FIG. 1. The second body includes a flat surface transverse to the longitudinal axis 52 such that, as device 10 is advanced toward the second body, the outer larger diameter 64 of the frusto-conical portion 38 will first engage such second body. Preferably, an automated tool 74 is used in turning and threadingly advancing the load detecting fastener 32, 74 and such automated tool 76 includes a computer control system 78 capable of controlling and detecting the location of the load detecting fastener 32, 74. As the load detecting fastener 32, 74 is advanced toward and tightened against the second body, the device 10 is clamped between the first and second bodies thereby compressing the device 10 and causing the shank 12 to be loaded in tension. During the initial loading, as indicated in the diagrammatic graph of FIG. 8 depicting torque on the vertical axis and the angle A to which the fastener has been turned, the torque which is representative of the fastener load steadily linearly increases as depicted by line 80. Advantageously, upon reaching a desired minimum preload condition represented by a torque level of Tₚ and in light of the construction of the device 10, the frusto-conical portion 36 plastically deforms longitudinally toward the first body 28, 72 thereby allowing the disk shaped bottoming surface 46 of the annular portion 36 to be drawn to and abut the second body, i.e. plate 24. Because the frusto-conical portion 38 undergoes plastic deformation, as depicted by line 81, minimal torque is required for advancing the disk shaped bottoming surface 46 onto the second body. The bottoming surface 46 thus travels a distance defined by the longitudinal distance between the frusto-conical surface inner smaller diameter 62 and the outer larger diameter 64 until it abuts the second body.

After the frusto-conical portion 38 undergoes plastic deformation and the disk shaped bottoming surface 46 comes in contact with and abuts the second body, continued tightening and threadingly advancing the load detecting fastener 32, 74 will cause additional load to be placed onto the shank 12 as depicted by line 82 in the diagrammatic graph of FIG. 8. As can be appreciated, at this point, it has been established that the desired minimum preload condition corresponding to the torque Tₚ has been obtained. Additional loading of the shank 12 can be provided if desired by further turning and threadingly advancing the load detecting fastener 32, 74 knowing that the desired minimum preload condition represented by the torque Tₚ has been attained.

While the invention has been described as having specific embodiments, it will be understood that it is capable of further modification. This application is, therefore, intended to cover any variations, uses, or adaptations of the invention following the general principles thereof and including such departures from the present disclosure as come within known or customary practice in the art to which this invention pertains and fall within the limits of the appended claims.

What is claimed is:

1. A device for establishing that a desired minimum preload condition has been attained in a fastener shank used in maintaining two bodies together when the device is located and clamped between the two bodies, said device comprising:
an annular portion including a longitudinally extending central bore adapted to receive the fastener shank, said central bore having a first end at one longitudinal end and a second end at its opposite longitudinal end;
said annular portion including a disk shaped bottoming surface at said first end of said bore and a top area at said second end of said bore;
said bottoming surface being transverse to said central bore;
an annular portion thickness being defined between said disk shaped bottoming surface and said top area;
a frusto-conical portion circumscribing and integrally formed with said annular portion, said frusto-conical portion including a frusto-conical bottoming surface having an inner smaller diameter abutting said disk shaped bottoming surface and an outer larger diameter being in a plane transverse to said central bore and longitudinally spaced from said disk shaped bottoming surface;
said frusto-conical portion including a top frusto-conical area adjacent said annular portion top area;
a frusto-conical thickness being defined between said frosto-conical bottoming surface and said top frusto-conical area; and,
wherein said device is formed of a material whereby, upon placement of a fastener shank through said central bore and use of the fastener shank in drawing the two bodies together, clamping said device therebetween and reaching a desired minimum preload condition in the fastener shank, said frusto-conical portion plastically deforms longitudinally allowing said disk shaped bottoming surface to be drawn to and abut one of the bodies.

2. The device of claim 1 wherein said annular portion thickness and said frusto-conical thickness are both 0.25 to 0.7 times the sum of the frusto-conical portion smaller diameter less the central bore diameter, and said frusto-conical bottoming surface forms an angle with a plane transverse to said longitudinally extending central bore of between 10 and 30 degrees.

3. The device of claim 2 wherein a first body is integrally formed with said device adjacent said annular portion top area and said first body includes a threaded bore collinear with said annular portion central bore, said threaded bore adapted to threadingly engage a threaded shank, said first body further including tool engaging surfaces whereby said first body and integral device may be turned about the threaded shank and threadingly advanced toward a second body.

4. The device of claim 3 wherein said annular portion central bore is also threaded and is adapted to threadingly engage the threaded shank.

5. The device of claim 4 wherein radius surfaces extend between said tool engaging surfaces and said frusto-conical area.

6. The device of claim 5 wherein said material comprises steel having carbon content of less than 0.3%.

7. The device of claim 2 wherein said material comprises steel having carbon content of less than 0.3%.

8. The device of claim 2 wherein a first body is integrally formed with said device adjacent said annular portion top area, said first body including tool engaging surfaces, and wherein a fastener shank is integrally formed with said device filling said annular portion central bore and extending longitudinally therefrom beyond said disk shaped bottoming surface.

9. The device of claim 8 wherein said fastener shank is at least partially threaded and adapted to threadingly engage a threaded bore in a second body whereby said first body and integral device may be turned and threadingly advanced toward the second body and into the second body threaded bore.

10. The device of claim 9 wherein said material comprises steel having carbon content of less than 0.3%.

11. The device of claim 3 wherein said material comprises steel having carbon content of less than 0.3%.

12. The device of claim 4 wherein said material comprises steel having carbon content of less than 0.3%.

13. The device of claim 1 wherein a first body is integrally formed with said device adjacent said annular portion top area and said first body includes a threaded bore collinear with said annular portion central bore, said threaded bore adapted to threadingly engage a threaded shank, said first body further including tool engaging surfaces whereby said first body and integral device may be turned about the threaded shank and threadingly advanced toward a second body.

14. The device of claim 13 wherein said annular portion central bore is also threaded and is adapted to threadingly engage the threaded shank.

15. The device of claim 14 wherein radius surfaces extend between said tool engaging surfaces and said frusto-conical area, said radius surfaces forming part of said annular portion top area.

16. The device of claim 15 wherein said material comprises steel having carbon content of less than 0.3%.

17. The device of claim 1 wherein a first body is integrally formed with said device adjacent said annular portion top area, said first body including tool engaging surfaces, and wherein a fastener shank is integrally formed with said device filling said annular portion central bore and extending longitudinally therefrom beyond said disk shaped bottoming surface.

18. The device of claim 17 wherein said fastener shank is at least partially threaded and adapted to threadingly engage a threaded bore in a second body whereby said first body and integral device may be turned and threadingly advanced toward the second body and into the second body threaded bore.

19. The device of claim 18 wherein said material comprises steel having carbon content of less than 0.3%.

20. The device of claim 1 wherein said material comprises steel having carbon content of less than 0.3%.

21. A device for establishing that a desired minimum preload condition has been attained in a fastener shank used in maintaining two bodies together when the device is located and clamped between the bodies, said device comprising:
an annular portion including a longitudinally extending central bore adapted to receive the fastener shank, said central bore having a first end at one longitudinal end and a second end at its opposite longitudinal end;
said annular portion including a disk shaped bottoming surface at said first end of said bore and a top area at said second end of said bore;
said bottoming surface being transverse to said central bore;
an annular portion thickness being defined between said disk shaped bottoming surface and said top area;
a frusto-conical portion circumscribing and integrally formed with said annular portion, said frusto-conical portion including a frusto-conical bottoming surface having an inner smaller diameter abutting said disk shaped bottoming surface and an outer larger diameter being in a plane transverse to said central bore and longitudinally spaced from said disk shaped bottoming surface;
said frusto-conical portion including a top frusto-conical area adjacent said annular portion top area;
a frusto-conical thickness being defined between said frosto-conical bottoming surface and said top frusto-conical area;
wherein said annular portion thickness and said frusto-conical thickness are both 0.25 to 0.7 times the sum of the frusto-conical portion smaller diameter less the central bore diameter, and said device is formed of a material whereby, upon placement of a fastener shank through said central bore and use of the fastener shank in drawing the two bodies together, clamping said device therebetween and reaching a desired minimum preload condition in the fastener shank, said frusto-conical portion plastically deforms longitudinally allowing said disk shaped bottoming surface to be drawn to and abut one of the bodies.

22. The device of claim 21 wherein said material comprises steel having carbon content of less than 0.3%.

23. A device for establishing that a desired minimum preload condition has been attained in a fastener shank used in maintaining two bodies together when the device is located and clamped between the bodies, said device comprising:
an annular portion including a longitudinally extending central bore adapted to receive the fastener shank, said central bore having a first end at one longitudinal end and a second end at its opposite longitudinal end;
said annular portion including a disk shaped bottoming surface at said first end of said bore and a top area at said second end of said bore;
said bottoming surface being transverse to said central bore;
an annular portion thickness being defined between said disk shaped bottoming surface and said top area;
a frusto-conical portion circumscribing and integrally formed with said annular portion, said frusto-conical portion including a frusto-conical bottoming surface having an inner smaller diameter abutting said disk shaped bottoming surface and an outer larger diameter being in a plane transverse to said central bore and longitudinally spaced from said disk shaped bottoming surface;
said frusto-conical portion including a top frusto-conical area adjacent said annular portion top area;
a frusto-conical thickness being defined between said frosto-conical bottoming surface and said top frusto-conical area;
wherein said frusto-conical bottoming surface forms an angle with a plane transverse to said longitudinally extending central bore of between 10 and 30 degrees, and said device is formed of a material whereby, upon placement of a fastener shank through said central bore and use of the fastener shank in drawing the two bodies together, clamping said device therebetween and reaching a desired minimum preload condition in the fastener shank, said frusto-conical portion plastically deforms longitudinally allowing said disk shaped bottoming surface to be drawn to and abut one of the bodies.

24. The device of claim 23 wherein said material comprises steel having carbon content of less than 0.3%.
